(19) United States
(12) Patent Application Publication
(10) Pub. No.: US 2024/0020760 A1
(43) Pub. Date: Jan. 18, 2024

(54) SYSTEMS AND METHODS FOR STREAMLINING USER INTERACTION IN A USER EVALUATION PROCESS

(71) Applicant: Capital One Services, LLC, McLean, VA (US)

(72) Inventors: Brandon Avery GREENE, Middletown, DE (US); Ebrima N. CEESAY, Vienna, VA (US)

(73) Assignee: Capital One Services, LLC, McLean, VA (US)

(21) Appl. No.: 17/863,756

(22) Filed: Jul. 13, 2022

(51) Int. Cl. G06Q 40/02; G06Q 40/00

(52) U.S. Cl. CPC G06Q 40/025; G06Q 40/12

(57) ABSTRACT

Embodiments disclosed are directed to a computing system that performs operations for streamlining user interaction in a user evaluation process. The computing system receives, at a first time, a request to update an account balance of a user account with a differential amount. The computing system determines a source of the request. The computing system generates a priority level for the request based on the determined source of the request. The computing system processes the request based on the generated priority level. The computing system generates a risk model associated with the user account based on electronic information associated with the user account. The computing system determines a supplemental amount associated with the user account based on the generated risk model. The computing system determines whether the differential amount is less than or equal to the supplemental amount. The computing system automatically updates the account balance of the user account, at a second time later than the first time, with the differential amount responsive to determining that the differential amount is less than or equal to the supplemental amount.

### TECHNICAL FIELD

Embodiments relate to a user evaluation process, specifically systems and methods for streamlining user interaction in a user evaluation process.

### BACKGROUND

Current systems that evaluate users as part of an approval process often rely on extensive user interaction to provide information needed for systems to complete the evaluation. An example of such a system is a banking system for providing microloans to customers. In order to efficiently and accurately evaluate users, systems usually require much effort from the customers to provide information such as personal financial information. This extensive user interaction can present problems especially in circumstances when the customers have limited access to Internet and/or brick-and-mortar stores associated with the systems.

### SUMMARY

Provided herein are system, apparatus, article of manufacture, method and/or computer program product embodiments, and/or combinations and sub-combinations thereof, for streamlining user interaction in a user evaluation process.

Several embodiments are directed to computer-implemented methods for streamlining user interaction in a user evaluation process. For example, a computer-implemented method can include receiving, by a management service of a cloud server at a first time, a request to update an account balance of a user account with a differential amount. The computer-implemented method can further include determining, by the management service of the cloud server, a source of the request. The computer-implemented method can further include generating, by the management service of the cloud server, a priority level for the request based on the determined source of the request. The computer-implemented method can further include processing, by the management service of the cloud server, the request based on the generated priority level. The computer-implemented method can further include generating, by an analysis service of the cloud server, a risk model associated with the user account based on electronic information associated with the user account. The computer-implemented method can further include determining, by the analysis service of the cloud server, a supplemental amount associated with the user account based on the generated risk model. The computer-implemented method can further include determining, by the analysis service of the cloud server, whether the differential amount is less than or equal to the supplemental amount. Subsequently, the computer-implemented method can further include automatically updating the account balance of the user account, by the management service of the cloud server at a second time later than the first time, with the differential amount responsive to determining that the differential amount is less than or equal to the supplemental amount.

In several embodiments, the source of the request can include an application associated with the user account, a vendor system, or a card associated with the user account.

In several embodiments, the computer-implemented method of the generating the priority level for the request can include generating, by the management service of the cloud server, a first priority level for the request from the card associated with the user account or the vendor system, or generating, by the management service of the cloud server, a second priority level for the request from the application associated with the user account. In several embodiments, the first priority level can be different from the second priority level.

In several embodiments, the computer-implemented method of the processing the request can include processing, by the management service of the cloud server, the request within a first time period based on the generated first priority level, or processing, by the management service of the cloud server, the request within a second time period based on the generated second priority level.

In several embodiments, the computer-implemented method can further include retrieving, by the cloud server, the electronic information associated with the user account; and performing, by the cloud server, verification of the retrieved electronic information.

In several embodiments, the electronic information can include pieces of electronic information. The computer-implemented method of the generating the risk model can further include classifying, by the analysis service of the cloud server, the supplemental amount as a classified supplemental amount using a supplemental amount determination machine learning (ML) system trained by a process. In several embodiments, the process can include classifying each piece of electronic information as a classified piece of electronic information. The process can further include generating, for each classified piece of electronic information, a respective predicted supplemental amount. The process can further include generating, for each predicted supplemental amount, a respective predicted probability value that the predicted supplemental amount will be repaid within a respective predetermined period of time. The process can further include modifying, based on the respective predicted probability value, the respective predicted supplemental amount to generate a respective modified predicted supplemental amount. The process can further include generating the classified supplemental amount based on the modified predicted supplemental amounts. Subsequently, the determining the supplemental amount of the computer-implemented method can include determining, by the analysis service of the cloud server using the supplemental amount determination ML system, the supplemental amount based on the classified supplemental amount.

In several embodiments, the computer-implemented method can further include automatically updating the account balance of the user account, by the management service of the cloud server at a second time later than the first time, with the supplemental amount responsive to determining that the differential amount is more than or equal to the supplemental amount.

In several embodiments, the computer-implemented method can further include automatically updating the account balance of the user account, by the management service of the cloud server at a second time later than the first time, with the supplemental amount responsive to determining that the differential amount is less than or equal to the supplemental amount.

Several embodiments are directed to computing systems. For example, a computing system can include a storage unit configured to store instructions. The computer system can further include a cloud server coupled to the storage unit and configured to process the stored instructions to perform operations that include receiving, at a first time, a request to update an account balance of a user account with a differential amount. The operations can further include determining a source of the request. The operations can further include generating a priority level for the request based on the determined source of the request. The operations can further include processing the request based on the generated priority level. The operations can further include generating a risk model associated with the user account based on electronic information associated with the user account. The operations can further include determining a supplemental amount associated with the user account based on the generated risk model. The operations can further include determining whether the differential amount is less than or equal to the supplemental amount. Subsequently, the operations can further include automatically updating the account balance of the user account, at a second time later than the first time, with the differential amount responsive to determining that the differential amount is less than or equal to the supplemental amount.

In several embodiments, the source of the request can include an application associated with the user account, a vendor system, or a card associated with the user account.

In several embodiments, the operation of the generating the priority level for the request can include generating a first priority level for the request from the card associated with the user account or the vendor system, or generating a second priority level for the request from the application associated with the user account. In several embodiments, the first priority level can be different from the second priority level.

In several embodiments, the operation of the processing the request can include processing the request within a first time period based on the generated first priority level, or processing the request within a second time period based on the generated second priority level.

In several embodiments, the operations can further include retrieving the electronic information associated with the user account; and performing verification of the retrieved electronic information.

In several embodiments, the electronic information can include pieces of electronic information. The operations can further include, to perform the generating the risk model, classifying the supplemental amount as a classified supplemental amount using a supplemental amount determination machine learning (ML) system trained by a process. The process can include classifying each piece of electronic information as a classified piece of electronic information. The process can further include generating, for each classified piece of electronic information, a respective predicted supplemental amount. The process can further include generating, for each predicted supplemental amount, a respective predicted probability value that the predicted supplemental amount will be repaid within a respective predetermined period of time. The process can further include modifying, based on the respective predicted probability value, the respective predicted supplemental amount to generate a respective modified predicted supplemental amount. The process can further include generating the classified supplemental amount based on the modified predicted supplemental amounts. The operations can further include determining, using the supplemental amount determination ML system, the supplemental amount based on the classified supplemental amount, to perform the operation of the determining the supplemental amount.

In several embodiments, the operations can further include automatically updating the account balance of the user account, by the management service of the cloud server at a second time later than the first time, with the supplemental amount responsive to determining that the differential amount is more than or equal to the supplemental amount.

In several embodiments, the operations can further include automatically updating the account balance of the user account, by the management service of the cloud server at a second time later than the first time, with the supplemental amount responsive to determining that the differential amount is less than or equal to the supplemental amount.

Several embodiments are directed to non-transitory computer readable media. For example, a non-transitory computer readable medium can include instructions for causing a processor to perform operations. The operations can include receiving, at a first time, a request to update an account balance of a user account with a differential amount. The operations can further include determining a source of the request. The operations can further include generating a priority level for the request based on the determined source of the request. The operations can further include processing the request based on the generated priority level. The operations can further include generating a risk model associated with the user account based on electronic information associated with the user account. The operations can further include determining a supplemental amount associated with the user account based on the generated risk model. The operations can further include determining whether the differential amount is less than or equal to the supplemental amount. Subsequently, the operations can further include automatically updating the account balance of the user account, at a second time later than the first time, with the differential amount responsive to determining that the differential amount is less than or equal to the supplemental amount.

In several embodiments, the source of the request can include an application associated with the user account, a vendor system, or a card associated with the user account.

In several embodiments, the operation of the generating the priority level for the request can include generating a first priority level for the request from the card associated with the user account or the vendor system, or generating a second priority level for the request from the application associated with the user account. In several embodiments, the first priority level can be different from the second priority level.

In several embodiments, the operation of the processing the request can include processing the request within a first time period based on the generated first priority level, or processing the request within a second time period based on the generated second priority level.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the art to make and use the embodiments.

FIGS. 1A and 1B illustrate an example system for streamlining user interaction in a user evaluation process according to some embodiments.

FIG. 2 illustrates an example method for streamlining user interaction in a user evaluation process according to some embodiments.

FIG. 3 is an example architecture of components implementing an example system for streamlining user interaction in a user evaluation process according to some embodiments.

### DETAILED DESCRIPTION

Embodiments disclosed herein relate to systems and methods for streamlining user interaction in a user evaluation process, such as a loan approval process. The loan approval process can be associated with a microloan, or any other type of loan, such as a temporary gap loan.

As described above, a system may need to evaluate a prioritized user request for receiving resources quickly in order to approve the user request. In order to perform the evaluation quickly but also accurately, the system needs user information associated with the user, e.g., to determine a trust level for the user. But in some circumstances, the user request may lack the required information and/or the user may be unable to provide additional information along with the request within the time period required to evaluate the prioritized user request. Current systems would not be able to approve the request in a timely fashion without the user providing the required information.

An example of a requested resource is a microloan and an example of a prioritized user request is a customer that may need quick loans of small amounts, such as microloans, for different events including unexpected events and/or emergencies (e.g., car issues, house repairs, etc.).

The technology described herein improves upon existing user evaluation systems by incorporating a process for processing a request based on a generated priority level, dynamically retrieving relevant user information (e.g., without requiring additional user input) and evaluating the retrieved user information. This technology is advantageous to backend systems that must accurately assess prioritized user requests for accessing system resources with minimal information provided from the user request. In some embodiments, the backend system may evaluate the prioritized user request responsive to receiving the user request and without any additional information being provided by the user. For example, in embodiments where the system resource is a microloan to be provided by a backend system, certain backend systems (e.g., maintained by banks) may, in response to receiving the user request, dynamically and automatically retrieve relevant user information from a plurality of different sources connected to the backend system. In some embodiments, the backend system may utilize machine learning algorithms to identify and rank the relevant user information to be used for evaluating the user request.

One example of such a user evaluation system may be used by a financial institution in evaluating and approving prioritized requests for microloan applications. In several embodiments, a financial institution can provide a microloan to a user for unexpected events and/or emergencies. In several embodiments, a user's card may be rejected by a merchant in a transaction due to insufficient funds associated with the user's card. In several embodiments, after determining that there are insufficient funds associated with the user's card, the system may transmit an indication to the user's device. The system may provide options to the user device for requesting the microloan from the system. In one example, the system may provide an interface for requesting the microloan by using an application, such as a mobile application, associated with the system. In another example, the interface provided by the system may allow the user device to contact the financial institution.

In several embodiments, before or after receiving an indication that there are insufficient funds associated with the user's card in the transaction, the backend system may transmit an alert to the user device. The alert may include one or more options for the microloan. In several embodiments, the alert may include, but not limited to, one or more Short Message Service (SMS) texts, emails, and/or indications to login to an application. An amount of the microloan may be associated with an amount due in the transaction. In several embodiments, the backend system may transmit an alert to the user device with the one or more options for the microloan before the card is rejected by merchant, and/or during a transaction of the card with the merchant. For example, the backend system may transmit an alert to the user device to indicate that, for example, “Do you want to obtain a microloan of an amount because it seems like that your account does not have sufficient funds for your current transaction. Please reply with yes or no.” In several embodiments, the backend system may transmit an alert to the user device of selecting the one or more options for the microloan. For example, the user device may send a reply with a text message with “yes”. In one example, the user device may send a reply by an application to indicate “yes”.

In several embodiments, the backend system may make a determination on whether to provide the microloan to the user, by using, for example, a machine learning (ML) system. In several embodiments, a predetermined amount of the microloan available to the user may be pre-approved by the backend system. In one example, the microloan may be approved upon receiving the user's reply to the alert from the backend system with the one or more options for the microloan. In another example, the microloan may be automatically approved for the user if the amount of the microloan is below the predetermined amount. In several embodiments, the backend system may transmit an alert to the user device that the user is approved for the microloan and the repayment time period of the microloan is a predefined period of time, based on the microloan is automatically approved with the amount of the microloan below the predetermined amount.

In several embodiments, the backend system may make the determination on whether to provide the microloan to the user within a short period of time, such as less than 1 minute. In several embodiments, the backend system can make one or more transactions associated with the microloan within a short period of time, such as less than 10 microseconds. In several embodiments, the backend system may provide the microloan to the user within a short period of time, such as less than a minute.

In several embodiments, the backend system may provide the microloan to the user with a small interest charge and/or a fee. In several embodiments, the backend system may provide the microloan to the user without an insufficient funds fee.

In several embodiments, the backend system may provide the microloan to the user by directly depositing the amount of the microloan into the user's card/account for immediate access by debit and/or credit payments. In several embodiments, the merchant may receive a notification from the backend system to repeat a failed transaction such as, for example, “please rescan the card,” after the microloan is provided to the user. In several embodiments, the user may withdraw cash in the amount of the microloan from one or more Automated Teller Machines (ATMs), and/or repay the amount of the microloan. In several embodiments, the user may repay the amount of the microloan by using the one or more ATMs, mobile devices, applications, and/or one or more accounts associated with the user, such as a checking account. One or more software on the ATMs associated with the financial institution can be augmented to allow the user to access funding for different events including unexpected events and/or emergencies. In several embodiments, the backend system may provide the microloan to be repaid based on one or more terms, for example, including a date of an incoming paycheck associated with the user, and/or over a predefined period of time.

In several embodiments, a microloan account may be created to be associated with a credit/debit card account of the user. In several embodiments, the microloan account may be created in addition to the credit/debit card account of the user, upon determining the amount of the microloan is above the predetermined amount. In several embodiments, the amount of the microloan may be considered as a replenishment of the user's available credit of a credit/debit card associated with the user, upon determining the amount of the microloan is below the predetermined amount. In one example, the microloan account may be automatically created for credit score purposes by the financial institution, and the account of the microloan maybe reported to a credit agency.

The following embodiments are described in sufficient detail to enable those skilled in the art to make and use the disclosure. It is to be understood that other embodiments are evident based on the present disclosure, and that system, process, or mechanical changes may be made without departing from the scope of an embodiment of the present disclosure.

In the following description, numerous specific details are given to provide a thorough understanding of the disclosure. However, it will be apparent that the disclosure may be practiced without these specific details. In order to avoid obscuring an embodiment of the present disclosure, some circuits, system configurations, architectures, and process steps are not disclosed in detail.

The drawings showing embodiments of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the disclosure may be operated in any orientation.

The term “module” or “unit” referred to herein may include software, hardware, or a combination thereof in an embodiment of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a module or unit is written in the system or apparatus claim section below, the module or unit is deemed to include hardware circuitry for the purposes and the scope of the system or apparatus claims.

The term “service” or “services” referred to herein can include a collection of modules or units. A collection of modules or units may be arranged, for example, in software or hardware libraries or development kits in embodiments of the present disclosure in accordance with the context in which the term is used. For example, the software or hardware libraries and development kits may be a suite of data and programming code, for example pre-written code, classes, routines, procedures, scripts, configuration data, or a combination thereof, that may be called directly or through an application programming interface (API) to facilitate the execution of functions of the system.

The modules, units, or services in the following description of the embodiments may be coupled to one another as described or as shown. The coupling may be direct or indirect, without or with intervening items between coupled modules, units, or services. The coupling may be by physical contact or by communication between modules, units, or services.

### System Overview and Function

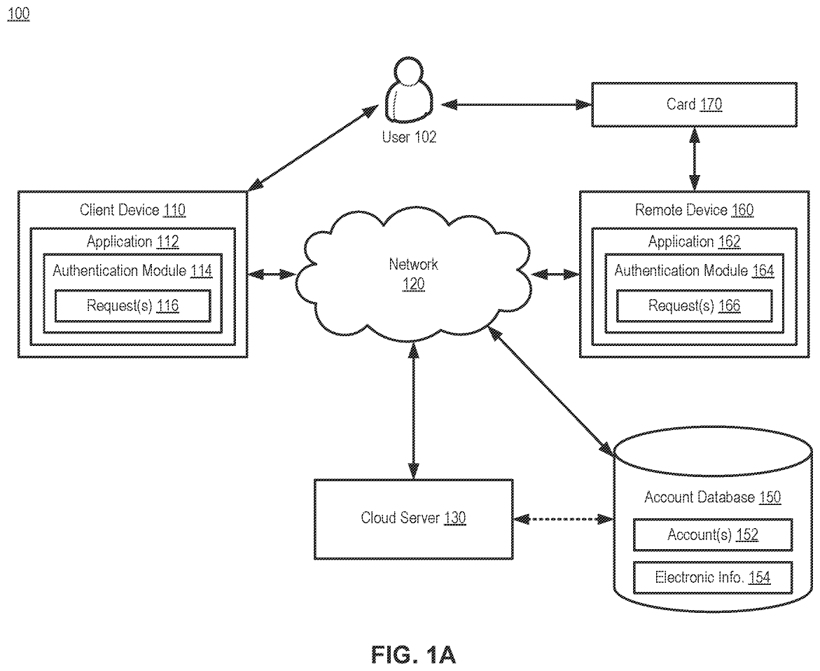

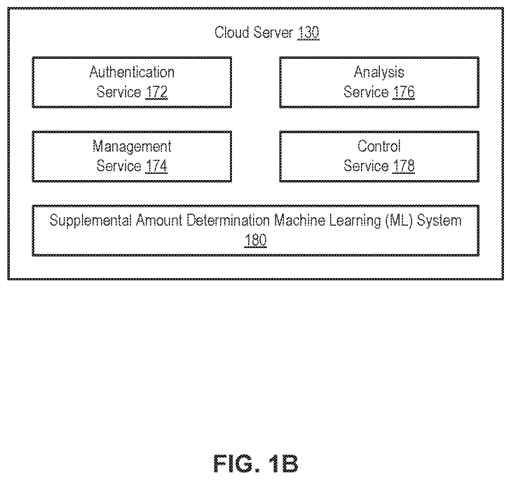

FIGS. 1A and 1B illustrate an example system 100 for streamlining user interaction in a user evaluation process, according to some embodiments. In several embodiments, as shown in FIG. 1A, system 100 can include a client device 110 associated with a user 102, a remote device 160 associated with a card 170, a network 120, a cloud server 130, and an account database 150 associated with an entity (e.g., a financial institution). In several embodiments, the client device 110 can further include an application 112 which, in several embodiments, includes an authentication module 114 having access to a plurality of device attributes stored on, or in association with, the client device 110. In several embodiments, the remote device 160 can further include an application 162 which, in several embodiments, includes an authentication module 164 having access to a plurality of device attributes stored on, or in association with, the remote device 160.

In several embodiments, as shown in FIG. 1B, the cloud server 130 can include an authentication service 172, a management service 174, an analysis service 176, a control service 178, a supplemental amount determination machine learning (ML) system 180, and any other suitable service, or any combination thereof.

In several embodiments, the card 170 may include a payment card associated with an account of a user (e.g., user 102) with a financial institution. In one example, the card 170 may include a debit card associated with the user (e.g., user 102). In another example, the card 170 may include a physical card and/or a virtual card. In another example, the card 170 may be a credit card associated with the user (e.g., user 102).

The client device 110 and the remote device 160 may be any of a variety of centralized or decentralized computing devices. For example, the client device 110 may be a mobile device, a laptop computer, or a desktop computer. The remote device 160 may be a point-of-sale (POS) device, a mobile device, a laptop computer, or a desktop computer. The remote device 160 may include a hardware system for processing transactions with a card (e.g., card 170). The remote device 160 may include any systems interface directly with one or more payment card networks. The remote device 160 may include contact or contactless capabilities for one or more transactions with the card 170.

In several embodiments, one or both of the client device 110 and the remote device 160 can function as a stand-alone device separate from other devices of the system 100. The term “stand-alone” can refer to a device being able to work and operate independently of other devices. In several embodiments, the client device 110 and the remote device 160 can store and execute the application 112 and the application 162, respectively.

Each of the application 112 and the application 162 may refer to a discrete software that provides some specific functionality. For example, the application 112 may be a mobile application that the user 102 can utilize to perform some functionality, whereas the application 162 may be a mobile application that a user can utilize to perform some functionality. For example and without limitation, the user 102 can utilize the functionality to perform banking, data transfers, or commercial transactions. In other embodiments, the application 112 may be a desktop application that the user 102 can utilize to perform the aforementioned functionalities.

In several embodiments, the client device 110 and the remote device 160 can be coupled to the cloud server 130 via a network 120. The cloud server 130 may be part of a backend computing infrastructure, including a server infrastructure of a company or institution, to which the application 112 and the application 162 belong. While the cloud server 130 is described and shown as a single component in FIGS. 1A and 1, this is merely an example. In some embodiments, the cloud server 130 can comprise a variety of centralized or decentralized computing devices. For example, the cloud server 130 may include a mobile device, a laptop computer, a desktop computer, grid-computing resources, a virtualized computing resource, cloud computing resources, peer-to-peer distributed computing devices, a server farm, or a combination thereof. The cloud server 130 may be centralized in a single room, distributed across different rooms, distributed across different geographical locations, or embedded within the network 120. While the devices comprising the cloud server 130 can couple with the network 120 to communicate with the client device 110 and the remote device 160, the devices of the cloud server 130 can also function as stand-alone devices separate from other devices of the system 100.

In several embodiments, the cloud server 130 can be implemented using cloud computing resources of a public or private cloud. A private cloud refers to a cloud environment similar to a public cloud with the exception that it is operated solely for a single organization.

In several embodiments, the cloud server 130 can couple to the client device 110 to allow the application 112 to function. For example, in several embodiments, both the client device 110 and the cloud server 130 can have at least a portion of the application 112 installed thereon as instructions on a non-transitory computer readable medium. The client device 110 and the cloud server 130 can both execute portions of the application 112 using client-server architectures, to allow the application 112 to function.

In several embodiments, the cloud server 130 can couple to the remote device 160 to allow the application 162 to function. For example, in several embodiments, both the remote device 160 and the cloud server 130 can have at least a portion of the application 162 installed thereon as instructions on a non-transitory computer readable medium. The remote device 160 and the cloud server 130 can both execute portions of the application 162 using client-server architectures, to allow the application 162 to function.

In several embodiments, the cloud server 130 can transmit requests and other data to, and receive requests, indications, device attributes, and other data from the client device 110 and/or the remote device 160 via the network 120. In several embodiments, the cloud server 130 can transmit requests 116 and other data to, and receive requests 116, indications, device attributes, and other data from, the authentication module 114 via the network 120. In several embodiments, the cloud server 130 can transmit requests 166 and other data to, and receive requests 166, indications, device attributes, and other data from, the authentication module 164 via the network 120.

The network 120 refers to a telecommunications network, such as a wired or wireless network. The network 120 can span and represent a variety of networks and network topologies. For example, the network 120 can include wireless communications, wired communications, optical communications, ultrasonic communications, or a combination thereof. For example, satellite communications, cellular communications, Bluetooth, Infrared Data Association standard (IrDA), wireless fidelity (Wi-Fi), and worldwide interoperability for microwave access (WiMAX) are examples of wireless communications that may be included in the network 120. Cable, Ethernet, digital subscriber line (DSL), fiber optic lines, fiber to the home (FTTH), and plain old telephone service (POTS) are examples of wired communications that may be included in the network 120. Further, the network 120 can traverse a number of topologies and distances. For example, the network 120 can include a direct connection, personal area network (PAN), local area network (LAN), metropolitan area network (MAN), wide area network (WAN), or a combination thereof. For illustrative purposes, in the embodiment of FIGS. 1A and 1, the system 100 is shown with the client device 110, the remote device 160, and the cloud server 130 as end points of the network 120. This, however, is an example and it is to be understood that the system 100 can have a different partition between the client device 110, the remote device 160, the cloud server 130, and the network 120. For example, the client device 110, the remote device 160, and the cloud server 130 can also function as part of the network 120.

In several embodiments, the client device 110 and the remote device 160 can include at least the authentication module 114 and the authentication module 164, respectively. In several embodiments, each of the authentication module 114 and the authentication module 164 may be a module of the application 112 and the application 162, respectively. In several embodiments, the authentication module 114 and the authentication module 164 can enable the client device 110 and the remote device 160, respectively, and/or the application 112 and the application 162, respectively, to receive requests and other data from, and transmit requests, device attributes, indications, and other data to, the authentication service 172 and/or the cloud server 130 via the network 120. In several embodiments, this may be done by having the authentication module 114 and the authentication module 164 couple to the authentication service 172 via an API to transmit and receive data as a variable or parameter.

In several embodiments, the cloud server 130 can include at least the authentication service 172. In several embodiments, the authentication service 172 may be implemented as a software application on the cloud server 130. In several embodiments, the authentication service 172 can enable receipt of electronic information (e.g., device attributes, online account properties) from the authentication module 114 and the authentication module 164. This may be done, for example, by having the authentication service 172 couple to the authentication module 114 and the authentication module 164 via a respective API to receive the electronic information as a variable or parameter. In several embodiments, the authentication service 172 can further enable storage of the electronic information in a local storage device or transmission (e.g., directly, or indirectly via the network 120) of the electronic information to the account database 150, or both for storage and retrieval.

The account database 150 may be a database or repository used to store the accounts 152, any other suitable data, or any combination thereof for an entity, such as a financial institution or bank. For example, the account database 150 can store, in a list or as table entries, one or more user accounts of the entity as the accounts 152. In several embodiments, the account database 150 may be a database or repository used to store the electronic information 154, any other suitable data, or any combination thereof associated with the accounts 152. For example, the account database 150 can store, in a list or as table entries, the electronic information associated with the accounts 152, such as one or more names, addresses, phone numbers, debit card numbers, credit card numbers, transaction histories, assets, checking account numbers, saving account numbers, direct deposits, annual income, credit histories, account information, and/or personal identification information associated with the accounts 152 as the electronic information 154.

In a variety of embodiments, the authentication service 172 of the cloud server 130 can provide for authenticating a user 102 that is attempting to make a transaction (e.g., a debit transaction, a balance transfer, etc.) using the card 170 with an entity, such as a merchant.

In several embodiments, the management service 174 of the cloud server 130 can receive a request to update an account balance of a user account (e.g., from user 102) with a differential amount. The management service 174 of the cloud server 130 can determine a source of the request. The management service 174 of the cloud server 130 can generate a priority level for the request based on the determined source of the request. The management service 174 of the cloud server 130 can process the request based on the generated priority level.

In several embodiments, the analysis service 176 may retrieve the electronic information associated with the user account, such as the electronic information 154 associated with the accounts 152 from database 150. The analysis service 176 of the cloud server 130 can generate a risk model associated with the user account based on electronic information associated with the user account. The analysis service 176 may determine a supplemental amount associated with the user account based on the generated risk model. The analysis service 176 of the cloud server 130 can classify the supplemental amount as a classified supplemental amount using a supplemental amount determination ML system 180 trained by a process including: classifying each piece of electronic information as a classified piece of electronic information; generating, for each classified piece of electronic information, a respective predicted supplemental amount; generating, for each predicted supplemental amount, a respective predicted probability value that the predicted supplemental amount will be repaid within a respective predetermined period of time; modifying, based on the respective predicted probability value, the respective predicted supplemental amount to generate a respective modified predicted supplemental amount, and generating the classified supplemental amount based on the modified predicted supplemental amounts. The analysis service 176 of the cloud server 130 can determine the supplemental amount based on the classified supplemental amount using the supplemental amount determination ML system 180. In several embodiments, the analysis service 176 may determine whether the differential amount is less than or equal to the supplemental amount.

The management service 174 of the cloud server 130 can automatically update the account balance of the user account with the differential amount responsive to determining that the differential amount is less than or equal to the supplemental amount.

In several embodiments, the control service 178 (e.g., one or more controllers) of the cloud server 130 can generate an electronic control signal configured to instruct the remote device (e.g., the remote device 160) to retry the attempt to settle the amount due using the card (e.g., card 170). In several embodiments, the control service 178 of the cloud server 130 can transmit the electronic control signal to the remote device.

In some aspects, system 100 described above significantly improves the state of the art from previous systems because it provides enhanced techniques for streamlining user interaction in a user evaluation process.

### Methods of Operation

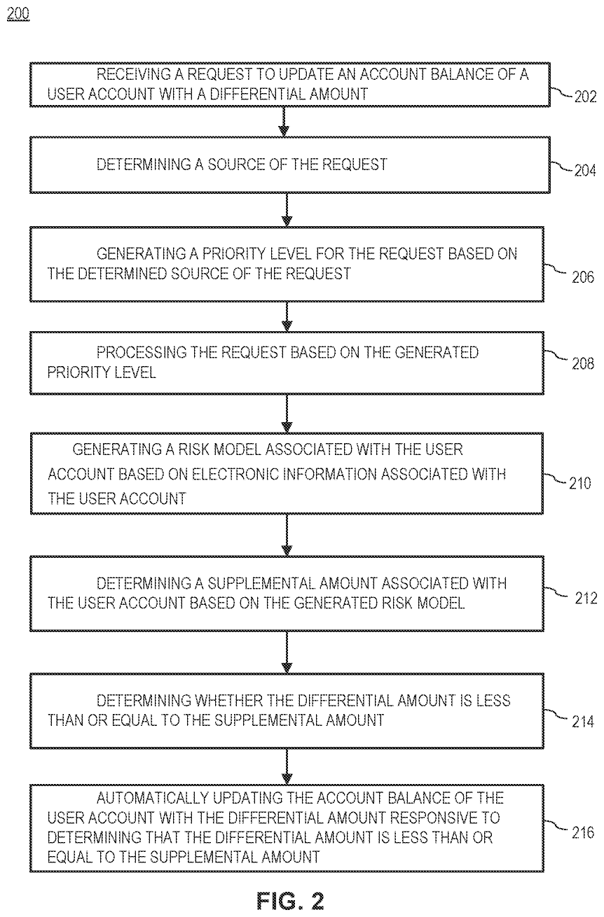

FIG. 2 illustrates an example method 200 according to some embodiments. In one example, method 200 is for operating of the system 100 to streamlining user interaction in a user evaluation process. For example, method 200 indicates how the cloud server 130 operates.

As shown in FIG. 2, in several embodiments, in operation 202 the cloud server 130 can receive, by a management service (e.g., management service 174) at a first time, a request to update an account balance of a user account with a differential amount. In some embodiments, the request may include a request for a micro loan with a loan amount (e.g., differential amount) to add to the account balance of the user account. The cloud server 130 can receive the request during a transaction associated with the user, for example, a debit card purchase or a withdrawal at an ATM.

In several embodiments, in operation 204 the cloud server 130 can determine, by the management service (e.g., management service 174), a source of the request. In several embodiments, the cloud server 130 can determine the source of the request from transaction data associated with the request. Transaction data may be data associated with one or more financial transactions made by a user. In an exemplary embodiment, the transaction data may include transaction information that includes at least a transaction amount (e.g., payment/purchase amount), transaction time and date, merchant or third party information relating to a transaction (e.g., brand name of the merchant), location information of where the financial transaction occurred, card present/absent, although additional or alternative transaction information may be used.

In some embodiments, the source of the request may include a system associated with the request, such as an application associated with the user account, a vendor system, or a card associated with the user account. In several embodiments, the cloud server 130 can receive the request from an application associated with the user account. For example, the cloud server 130 can receive a request for a microloan with an amount (e.g., a differential amount) from a user's mobile application, such as a mobile banking application. In several embodiments, the cloud server 130 can receive the request to complete a transaction from an ATM. For example, the cloud server 130 can receive an electronic notification indicating that an account balance of a user account is insufficient to complete a withdrawal transaction from the ATM machine, and a differential amount is needed to complete the withdrawal transaction.

In several embodiments, the cloud server 130 can receive the request to complete a transaction from a card. In several embodiments, the cloud server 130 can receive an electronic notification indicating that an attempt to settle an amount due using a card (e.g., card 170) has been denied by a remote device (e.g., remote device 160). In one example, a user (e.g., user 102) may attempt to make a purchase using the card 170. In one example, the card 170 may be denied by the remote device 160, such as a POS device, due to insufficient funds associated with the card 170. In some embodiments, a differential amount is determined to be added to the card (e.g., card 170) to settle the amount due. In one example, the amount due may include a first amount, and the funds available associated with the card 170 may include a second amount. In another example, the first amount may be larger than the second amount, or vice versa. In several embodiments, the differential amount may be determined, by the cloud server 130, based on the difference between the first amount and the second amount.

In several embodiments, in operation 206 the cloud server 130 can generate, by the management service, a priority level for the request based on the determined source of the request. The cloud server 130 can generate a first priority level for the request from the card associated with the user account or the vendor system. The cloud server 130 can generate a second priority level for the request from the application associated with the user account. In several embodiments, the first priority level can be different from the second priority level. For example, the cloud server 130 can generate a high priority level for the request from the card associated with the user account or the vendor system, and a low priority level from the mobile application associated with the user account.

In several embodiments, in operation 208 the cloud server 130 can process, by the management service of the cloud server, the request based on the generated priority level. The cloud server 130 can process the request within a first time period based on the generated first priority level. The cloud server 130 can process the request the request within a second time period based on the generated second priority level. In several embodiments, the first time period is less than the second time period. For example, the cloud server 130 can process the request from the application associated with the user account within two minutes. For example, the cloud server 130 can process the request from the card associated with the user account or the vendor system within a time period of less than 1 minute.

In several embodiments, the cloud server 130 can retrieve the electronic information associated with the user account. In several embodiments, the cloud server 130 can perform verification of the retrieved electronic information. In some examples, the cloud server 130 can retrieve and verify account information associated with the user account, including, but not limited to, identification information (e.g., name, address), income information (e.g., salary, earnings), account history information (e.g., credit application history), and transaction history information (e.g., average deposits, withdrawals and average balance associated with checking and/or saving account).

In several embodiments, in operation 210 the cloud server 130 can generate, by an analysis service (e.g., the analysis service 176) of the cloud server, a risk model associated with the user account based on electronic information associated with the user account. In several embodiments, the electronic information can include pieces of electronic information associated with the user account of a user (e.g., user 102). For example, the pieces of electronic information associated with the user account may include, but not limited to, pieces of electronic information associated with one or more names, addresses, phone numbers, debit card numbers, credit card numbers, transaction histories, checking account numbers, saving account numbers, direct deposits, annual income, credit histories, account information and/or personal identification information. In several embodiments, the risk model may be generated by a machine learning (ML) system to predict one or more risks associated with the user account in the user evaluation process.

In several embodiments, in operation 212 the cloud server 130 can determine, by the analysis service, a supplemental amount associated with the user account based on the generated risk model. In several embodiments, the supplemental amount may include a predetermined amount of a microloan available (e.g., a pre-approved amount) to the user.

In several embodiments, the cloud server 130 may classify, by the analysis service (e.g., the analysis service 176), the supplemental amount as a classified supplemental amount using a supplemental amount determination ML system (e.g., supplemental amount determination ML system 180) trained by a process. In several embodiments, the process may include a process of classifying each piece of electronic information as a classified piece of electronic information. In several embodiments, pieces of electronic information may be associated with one or more users, including but not limited to, the user 102. In several embodiments, pieces of electronic information may be associated with one or more users other than the user 102. For example, the pieces of electronic information associated with a user may include, but not limited to, pieces of electronic information associated with one or more names, addresses, phone numbers, debit card numbers, credit card numbers, transaction histories, checking account numbers, saving account numbers, direct deposits, annual income, credit histories, account information and/or personal identification information. In one example, the classified piece of electronic information may include, but not limited to, assets, debts, payroll deposits, and/or credit histories.

In several embodiments, the process may include a process of generating, for each classified piece of electronic information, a respective predicted supplemental amount. For example, a first predicted supplemental amount may be generated based on a first classified piece of electronic information, such as the assets. A second predicted supplemental amount may be generated based on a second classified piece of electronic information, such as the transaction histories.

In several embodiments, the process may include a process of generating, for each predicted supplemental amount, a respective predicted probability value that the predicted supplemental amount will be repaid within a respective predetermined period of time. In one example, a first predicted probability value may be generated for an event of the first predicted supplemental amount will be repaid within a respective predetermined period of time. In another example, a second predicted probability value may be generated for an event of the second predicted supplemental amount will be repaid within a respective predetermined period of time. In several embodiments, the process may include a process of modifying, based on the respective predicted probability value, the respective predicted supplemental amount to generate a respective modified predicted supplemental amount. In one example, a first modified predicted supplemental amount may be generated based on the first predicted probability value and the first predicted supplemental amount. In one example, a second modified predicted supplemental amount may be generated based on the second predicted probability value and the second predicted supplemental amount. In several embodiments, the process may include a process of generating the classified supplemental amount based on the modified predicted supplemental amounts. In one example, the classified supplemental amount may be generated based on the first modified predicted supplemental amount and the second modified predicted supplemental amount. In several embodiments, the analysis service (e.g., the analysis service 176) of the cloud server 130 can determine, using the supplemental amount determination ML system, the supplemental amount based on the classified supplemental amount. In several embodiments, the cloud server 130 can determine the supplemental amount based on the electronic information associated with the user account, using the supplemental amount determination ML system.

In several embodiments, in operation 214 the cloud server 130 can determine, by the analysis service (e.g., the analysis service 176), whether the differential amount is less than or equal to the supplemental amount.

In several embodiments, in operation 216 the cloud server 130 can automatically update the account balance of the user account at a second time later than the first time, with the differential amount responsive to determining that the differential amount is less than or equal to the supplemental amount. In one example, the cloud server 130 can automatically deposit the differential amount into the user account for immediate access by using debit and/or credit payments.

In several embodiments, the cloud server 130 can automatically update the account balance of the user account, by the management service of the cloud server at a second time later than the first time, with the supplemental amount responsive to determining that the differential amount is more than or equal to the supplemental amount. In several embodiments, the cloud server 130 can automatically updating the account balance of the user account, by the management service of the cloud server at a second time later than the first time, with the supplemental amount responsive to determining that the differential amount is less than or equal to the supplemental amount.

### Components of the System

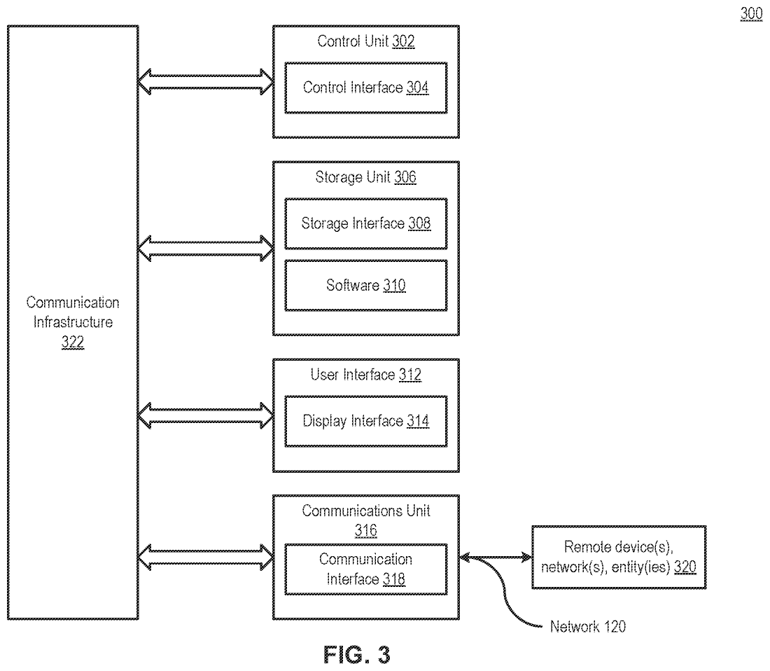

FIG. 3 is an example architecture 300 of components implementing the system 100 according to some embodiments. The components may be implemented by any of the devices described with reference to the system 100, such as the client device 110, the remote device 160, the cloud server 130, the account database 150, or a combination thereof. The components may be further implemented by any of the devices described with reference to the method 200.

In several embodiments, the components may include a control unit 302, a storage unit 306, a communication unit 316, and a user interface 312. The control unit 302 may include a control interface 304. The control unit 302 may execute a software 310 (e.g., the application 112, the authentication module 114, the application 162, the authentication module 164, the authentication service 172, the control service 178, or a combination thereof) to provide some or all of the machine intelligence described with reference to system 100. In another example, the control unit 302 may execute a software 310 to provide some or all of the machine intelligence described with reference to method 200.

The control unit 302 may be implemented in a number of different ways. For example, the control unit 302 may be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The control interface 304 may be used for communication between the control unit 302 and other functional units or devices of system 100 (e.g., the client device 110, the remote device 160, the cloud server 130, the account database 150, or a combination thereof) or those described with reference to method 200. The control interface 304 may also be used for communication that is external to the functional units or devices of system 100 or those described with reference to method 200. The control interface 304 may receive information from the functional units or devices of system 100 or method 200, or from remote devices 320, or may transmit information to the functional units or devices of system 100 or method 200, or to remote devices 320. The remote devices 320 refer to units or devices external to system 100 or method 200.

The control interface 304 may be implemented in different ways and may include different implementations depending on which functional units or devices of system 100, method 200, or remote devices 320 are being interfaced with the control unit 302. For example, the control interface 304 may be implemented with a pressure sensor, an inertial sensor, a microelectromechanical system (MEMS), optical circuitry, waveguides, wireless circuitry, wireline circuitry to attach to a bus, an application programming interface, or a combination thereof. The control interface 304 may be connected to a communication infrastructure 322, such as a bus, to interface with the functional units or devices of system 100, method 200, or remote devices 320.

The storage unit 306 may store the software 310. For illustrative purposes, the storage unit 306 is shown as a single element, although it is understood that the storage unit 306 may be a distribution of storage elements. Also for illustrative purposes, the storage unit 306 is shown as a single hierarchy storage system, although it is understood that the storage unit 306 may be in a different configuration. For example, the storage unit 306 may be formed with different storage technologies forming a memory hierarchical system including different levels of caching, main memory, rotating media, or off-line storage. The storage unit 306 may be a volatile memory, a nonvolatile memory, an internal memory, an external memory, or a combination thereof. For example, the storage unit 306 may be a nonvolatile storage such as nonvolatile random access memory (NVRAM), Flash memory, disk storage, or a volatile storage such as static random access memory (SRAM) or dynamic random access memory (DRAM).

The storage unit 306 may include a storage interface 308. The storage interface 308 may be used for communication between the storage unit 306 and other functional units or devices of system 100 or method 200. The storage interface 308 may also be used for communication that is external to system 100 or method 200. The storage interface 308 may receive information from the other functional units or devices of system 100, method 200, or from remote devices 320, or may transmit information to the other functional units or devices of system 100 or to remote devices 320. The storage interface 308 may include different implementations depending on which functional units or devices of system 100, method 200, or remote devices 320 are being interfaced with the storage unit 306. The storage interface 308 may be implemented with technologies and techniques similar to the implementation of the control interface 304.

The communication unit 316 may enable communication to devices, components, modules, or units of system 100, method 200, or remote devices 320. For example, the communication unit 316 may permit the system 100 to communicate between the client device 110, the remote device 160, the cloud server 130, the account database 150, or a combination thereof. In another example, the communication unit 316 may permit the functional units or devices described with reference to method 200 to communicate with each other. The communication unit 316 may further permit the devices of system 100 or method 200 to communicate with remote devices 320 such as an attachment, a peripheral device, or a combination thereof through the network 120.

As previously indicated, the network 120 may span and represent a variety of networks and network topologies. For example, the network 120 may include wireless communication, wired communication, optical communication, ultrasonic communication, or a combination thereof. For example, satellite communication, cellular communication, Bluetooth, IrDA, Wi-Fi, and WiMAX are examples of wireless communication that may be included in the network 120. Cable, Ethernet, DSL, fiber optic lines, FTTH, and POTS are examples of wired communication that may be included in the network 120. Further, the network 120 may traverse a number of network topologies and distances. For example, the network 120 may include direct connection, PAN, LAN, MAN, WAN, or a combination thereof.

The communication unit 316 may also function as a communication hub allowing system 100 to function as part of the network 120 and not be limited to be an end point or terminal unit to the network 120. The communication unit 316 may include active and passive components, such as microelectronics or an antenna, for interaction with the network 120.

The communication unit 316 may include a communication interface 318. The communication interface 318 may be used for communication between the communication unit 316 and other functional units or devices of system 100 or to remote devices 320. The communication interface 318 may receive information from the other functional units or devices of system 100, or from remote devices 320, or may transmit information to the other functional units or devices of the system 100 or to remote devices 320. The communication interface 318 may include different implementations depending on which functional units or devices are being interfaced with the communication unit 316. The communication interface 318 may be implemented with technologies and techniques similar to the implementation of the control interface 304.

The user interface 312 may present information generated by system 100. In several embodiments, a user can utilize the user interface 312 to interface with the devices of system 100 or remote devices 320. The user interface 312 may include an input device and an output device. Examples of the input device of the user interface 312 may include a keypad, buttons, switches, touchpads, soft-keys, a keyboard, a mouse, or any combination thereof to provide data and communication inputs. Examples of the output device may include a display interface 314. The control unit 302 may operate the user interface 312 to present information generated by system 100. The control unit 302 may also execute the software 310 to present information generated by system 100, or to control other functional units of system 100. The display interface 314 may be any graphical user interface such as a display, a projector, a video screen, or any combination thereof.

The above detailed description and embodiments of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The system 100 and the method 200 are cost-effective, highly versatile, and accurate, and may be implemented by adapting components for ready, efficient, and economical manufacturing, application, and utilization. Another important aspect of embodiments of the present disclosure is that they valuably support and service the trend of reducing costs, simplifying systems, and/or increasing system performance.

These and other valuable aspects of the embodiments of the present disclosure consequently further the state of the technology to at least the next level. While the disclosed embodiments have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the disclosure is not to be restricted except in light of the attached claims and their equivalents.

What is claimed is:

1. A computer-implemented method comprising:
receiving, by a management service of a cloud server at a first time, a request to update an account balance of a user account with a differential amount;
determining, by the management service of the cloud server, a source of the request;
generating, by the management service of the cloud server, a priority level for the request based on the determined source of the request;
processing, by the management service of the cloud server, the request based on the generated priority level;
generating, by an analysis service of the cloud server, a risk model associated with the user account based on electronic information associated with the user account;
determining, by the analysis service of the cloud server, a supplemental amount associated with the user account based on the generated risk model;
determining, by the analysis service of the cloud server, whether the differential amount is less than or equal to the supplemental amount; and
automatically updating the account balance of the user account, by the management service of the cloud server at a second time later than the first time, with the differential amount responsive to determining that the differential amount is less than or equal to the supplemental amount.

2. The computer-implemented method of claim 1, wherein the source of the request comprises an application associated with the user account, a vendor system, or a card associated with the user account.

3. The computer-implemented method of claim 2, wherein the generating the priority level for the request comprises:
generating, by the management service of the cloud server, a first priority level for the request from the card associated with the user account or the vendor system, or
generating, by the management service of the cloud server, a second priority level for the request from the application associated with the user account, wherein the first priority level is different from the second priority level.

4. The computer-implemented method of claim 3, wherein the processing the request comprises:
processing, by the management service of the cloud server, the request within a first time period based on the generated first priority level, or
processing, by the management service of the cloud server, the request within a second time period based on the generated second priority level.

5. The computer-implemented method of claim 1, further comprising:
retrieving, by the cloud server, the electronic information associated with the user account; and
performing, by the cloud server, verification of the retrieved electronic information.

6. The computer-implemented method of claim 1, wherein:
the electronic information comprises pieces of electronic information;
the generating the risk model comprises classifying, by the analysis service of the cloud server, the supplemental amount as a classified supplemental amount using a supplemental amount determination machine learning (ML) system trained by a process comprising:
classifying each piece of electronic information as a classified piece of electronic information,
generating, for each classified piece of electronic information, a respective predicted supplemental amount,
generating, for each predicted supplemental amount, a respective predicted probability value that the predicted supplemental amount will be repaid within a respective predetermined period of time,
modifying, based on the respective predicted probability value, the respective predicted supplemental amount to generate a respective modified predicted supplemental amount, and
generating the classified supplemental amount based on the modified predicted supplemental amounts; and
the determining the supplemental amount comprises determining, by the analysis service of the cloud server using the supplemental amount determination ML system, the supplemental amount based on the classified supplemental amount.

7. The computer-implemented method of claim 1, further comprising: automatically updating the account balance of the user account, by the management service of the cloud server at a second time later than the first time, with the supplemental amount responsive to determining that the differential amount is more than or equal to the supplemental amount.

8. The computer-implemented method of claim 1, further comprising: automatically updating the account balance of the user account, by the management service of the cloud server at a second time later than the first time, with the supplemental amount responsive to determining that the differential amount is less than or equal to the supplemental amount.

9. A computing system comprising:
a storage unit configured to store instructions;
a cloud server coupled to the storage unit and configured to process the stored instructions to perform operations comprising:
receiving, at a first time, a request to update an account balance of a user account with a differential amount;
determining a source of the request;
generating a priority level for the request based on the determined source of the request;
processing the request based on the generated priority level;
generating a risk model associated with the user account based on electronic information associated with the user account;
determining a supplemental amount associated with the user account based on the generated risk model;
determining whether the differential amount is less than or equal to the supplemental amount; and
automatically updating the account balance of the user account, at a second time later than the first time, with the differential amount responsive to determining that the differential amount is less than or equal to the supplemental amount.

10. The computing system of claim 9, wherein the source of the request comprises an application associated with the user account, a vendor system, or a card associated with the user account.

11. The computing system of claim 10, wherein the operation of the generating the priority level for the request comprises:
generating a first priority level for the request from the card associated with the user account or the vendor system, or
generating a second priority level for the request from the application associated with the user account, wherein the first priority level is different from the second priority level.

12. The computer-implemented method of claim 11, wherein the operation of the processing the request comprises:
processing the request within a first time period based on the generated first priority level, or
processing the request within a second time period based on the generated second priority level.

13. The computing system of claim 9, wherein the operations further comprise:
retrieving the electronic information associated with the user account; and
performing verification of the retrieved electronic information.

14. The computing system of claim 9, wherein:
the electronic information comprises pieces of electronic information;
the operations further comprise classifying the supplemental amount as a classified supplemental amount using a supplemental amount determination machine learning (ML) system trained by a process comprising:
classifying each piece of electronic information as a classified piece of electronic information,
generating, for each classified piece of electronic information, a respective predicted supplemental amount,
generating, for each predicted supplemental amount, a respective predicted probability value that the predicted supplemental amount will be repaid within a respective predetermined period of time,
modifying, based on the respective predicted probability value, the respective predicted supplemental amount to generate a respective modified predicted supplemental amount, and
generating the classified supplemental amount based on the modified predicted supplemental amounts; and
to perform the determining the supplemental amount, the operations further comprise comprises determining using the supplemental amount determination ML system, the supplemental amount based on the classified supplemental amount.

15. The computing system of claim 9, wherein the operations further comprise: automatically updating the account balance of the user account, at a second time later than the first time, with the supplemental amount responsive to determining that the differential amount is more than or equal to the supplemental amount.

16. The computing system of claim 9, wherein the operations further comprise: automatically updating the account balance of the user account, at a second time later than the first time, with the supplemental amount responsive to determining that the differential amount is less than or equal to the supplemental amount.

17. A non-transitory computer readable medium including instructions for causing a processor to perform operations comprising:
receiving, at a first time, a request to update an account balance of a user account with a differential amount;
determining a source of the request;
generating a priority level for the request based on the determined source of the request;
processing the request based on the generated priority level;
generating a risk model associated with the user account based on electronic information associated with the user account;
determining a supplemental amount associated with the user account based on the generated risk model;
determining whether the differential amount is less than or equal to the supplemental amount; and
automatically updating the account balance of the user account, at a second time later than the first time, with the differential amount responsive to determining that the differential amount is less than or equal to the supplemental amount.

18. The non-transitory computer readable medium of claim 17, wherein the source of the request comprises an application associated with the user account, a vendor system, or a card associated with the user account.

19. The non-transitory computer readable medium of claim 18, wherein the operation of the generating the priority level for the request comprises:
generating a first priority level for the request from the card associated with the user account or the vendor system, or
generating a second priority level for the request from the application associated with the user account, wherein the first priority level is different from the second priority level.

20. The non-transitory computer readable medium of claim 19, wherein the operation of the processing the request comprises:
processing the request within a first time period based on the generated first priority level, or
processing the request within a second time period based on the generated second priority level.
